(19) United States
(12) Patent Application Publication
(10) Pub. No.: US 2003/0066320 A1
(43) Pub. Date: Apr. 10, 2003

(54) Anti-theft device for a vehicle with a handle mounted actuator

(76) Inventor: Robert A. Vito, Berwyn, PA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/974,233

(22) Filed: Oct. 10, 2001

(51) Int. Cl. B62H 5/00

(52) U.S. Cl. 70/233

(57) ABSTRACT

An anti-theft device for securing a handle mounted actuator relative to a handle of a vehicle is provided, and includes a sheath having first and second ends. The sheath includes a handle encompassing portion extending between the first and second ends, with the handle encompassing portion being adapted to slide over at least a portion of the handle. The sheath further includes a control lever encompassing portion attached to the handle encompassing portion and extending generally between the first and second ends. The control lever encompassing portion and the handle encompassing portion generally encompass a majority of the vehicle handle and control lever, such as a brake or clutch. A lock is connected to the sheath and is adapted to secure the anti-theft device to the handle. The anti-theft device secures the control lever in the second position when the sheath is slid over the handle and the control lever.

### BACKGROUND

The present invention is related to an anti-theft device. More particularly, the invention is directed to an anti-theft device for use in connection with motor vehicles having a handle-mounted actuator, such as motorcycles, all-terrain vehicles (ATV's), snowmobiles, personal water craft and the like.

It is known in the art to provide an auxiliary locking device to protect motorcycles from theft or unauthorized use. Previously, it was preferred to use a bar or cable which engaged the wheel of the motorcycle with the fork or frame to prevent rotation. However, such devices where sometimes overlooked by the owner, resulting in damage to the vehicle and/or injury to the owner.

It has also been known to provide a control lever lock which is used to lock the brake lever or clutch lever of such vehicles. One such device utilized two clamp arms which could be clamped around the control lever and the hand grip end (handle) of a handlebar. This could be used to lock the control lever in position and could also lock the throttle control built into the handle. However, these prior known devices where not highly visible and could be disabled by a thief by simply cutting the control lever outside of the area held between the clamp arms. Such cutting of the control lever has been proven to be relatively easy due to the relative softness of the control lever material. Additionally, many handle grips are secured the remainder of the handlebars via a screw that is inserted into an outer end of the handle grip and is fastened into place along the longitudinal axis of the handle grip. Thieves have also been able to bypass the above mentioned two arm clamp lock by removing the screw to allow the handle grip to be removed along with the two arm clamp lock. To the extent that the clamp arms remained in position attached only to a portion of the handle bar, the vehicle could then be driven away by the thief to a remote location where more advanced tools could be brought to bear on removing the clamp arms from the handle.

Clearly, there is a need for a locking device that is both highly visible and which offers more protection to prevent unauthorized use or theft of a motorcycle, ATV, snowmobile, personal watercraft or other such vehicles than the prior known devices. Such a device should not only be highly visible, but should deter theft and/or unauthorized use by providing improved protection of the control actuator. The anti-theft device should also be easily installed and removed by the user and be visibly apparent when installed in the event that a thief attempts to take the entire vehicle with the device locked in position.

### SUMMARY

Briefly stated, the present invention provides an anti-theft device for positionally securing a handle mounted actuator relative to a handle of a vehicle. The handle mounted actuator includes a control lever which is movable from an initial position, spaced from the handle, to a second position, in which the control lever is moved toward the handle to define, in combination with the handle, a secured envelope volume. The anti-theft device includes a sheath having a first end and a second end. The sheath includes a handle encompassing portion extending between the first and second ends, with the handle encompassing portion being adapted to slide over at least a portion of the handle. The sheath further includes a control lever encompassing portion attached to the handle encompassing portion and extending generally between the first and second ends. The control lever encompassing portion and the handle encompassing portion generally encompass the secured envelope volume and are adapted to slide over a majority of the control lever. A lock is connected to the sheath and is adapted to secure the anti-theft device to the handle. The anti-theft device is adapted to secure the control lever in the second position when the sheath is slid over the handle and the control lever.

In another aspect, an anti-theft device for positionally securing a handle mounted actuator relative to a handle is provided. The handle mounted actuator includes a control lever which is moveable from an initial position, spaced from the handle, to a second position, in which the control lever is moved toward the handle. The anti-theft device includes a sheath having a first end and a second end. The sheath includes a handle encompassing portion extending between the first and second ends and having a longitudinal axis. The handle encompassing portion is adapted to slide over at least a portion of the handle. A control lever encompassing portion is attached to the handle encompassing portion and extends generally between the first and second ends. The control lever encompassing portion includes a tapered section so that a control lever encompassing area defined by the control lever encompassing portion, as measured in a plane generally perpendicular to the longitudinal axis, generally decreases from the first end toward the second end of the sheath. A lock is connected to the sheath and is adapted to secure the anti-theft device to the handle, so that when the sheath is slid over the handle and the handle mounted actuator, the tapered section of the anti-theft device is adapted to slidably engage and displace the control lever to the second position.

In another aspect, the invention provides a combination of a vehicle and an anti-theft device. The combination includes the vehicle with a handle operatively connected to the vehicle having a handle mounted actuator located thereon which includes a control lever that is moveable from an initial position, spaced from the handle, to a second position, in which the control lever is moved toward the handle, to define, in combination with the handle, a secured envelope volume. The anti-theft device is detachably engaged with the handle and includes a sheath having first and second ends. The sheath includes a handle encompassing portion extending between the first and second ends, with the handle encompassing portion being slidable over at least a portion of the handle. A control lever encompassing portion is attached to the handle encompassing portion and extends generally between the first and second ends. The control lever encompassing portion and the handle encompassing portion generally encompass the secured envelope volume and are slidable over a majority of the control lever. A lock is connected to the sheath and secures the anti-theft device to the handle, so that when the sheath is slid over the handle and the control lever, the anti-theft device secures the control lever in the second position.

In another aspect, the invention provides a method of positionally securing a handle mounted actuator relative to a handle. The handle mounted actuator preferably includes a control lever having an initial position, spaced from the handle, and a second position, in which the control lever is moved toward the handle. The method includes:

Moving the control lever into the second position; and

Sliding a sheath onto the handle and the control lever, the sheath enclosing a majority of the control lever and handle and retaining the control lever in the second position.

### BRIEF DESCRIPTION OF THE DRAWING(S)

The foregoing summary as well as the following detailed description of the preferred embodiments of the present invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view of an anti-theft device in accordance with the present invention being installed over a handle and handle mounted actuator of a vehicle.

FIG. 2 is a perspective view showing the anti-theft device installed over the handle and actuator, with the lock being installed.

FIG. 3 is a cross-sectional view taken along lines 3-3 in FIG. 2 showing the position of the handle and actuator within the anti-theft device.

FIG. 4 is a cross-sectional view taken along lines 4-4 in FIG. 3.

FIG. 5 is a perspective view of a second embodiment of an anti-theft device in accordance with the present invention.

FIG. 6 is a partial cross-sectional view taken along lines 6-6 in FIG. 5.

### DETAILED DESCRIPTION OF THE PREFERRED EMBODIMENT(S)

Certain terminology is used in the following description for convenience only and is not considered limiting. The words “right”, “left”, “lower” and “upper” designate directions in the drawings to which reference is made. This terminology includes the words specifically noted above, derivatives thereof and words of similar import. The term “vehicle” as used in the claims and in the corresponding portions of the specification, means “any one of a motorcycle, a moped, an all terrain vehicle, a jet ski, a snowmobile, and a personal water craft.” Additionally, the terms “a” and “one” are defined as including one or more of the referenced item unless specifically noted.

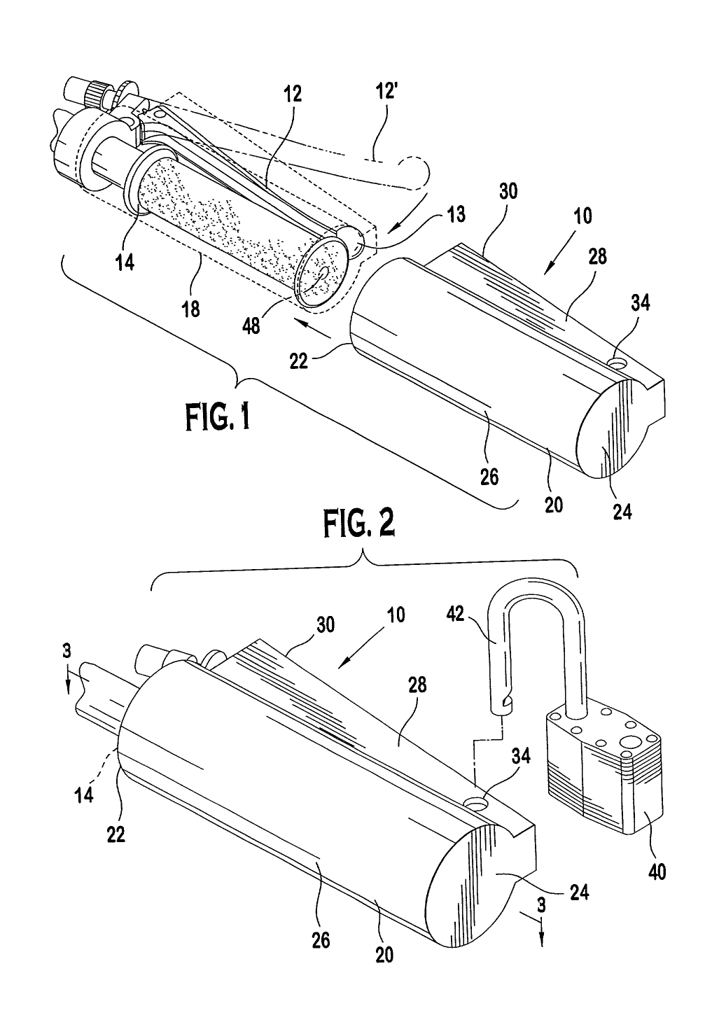

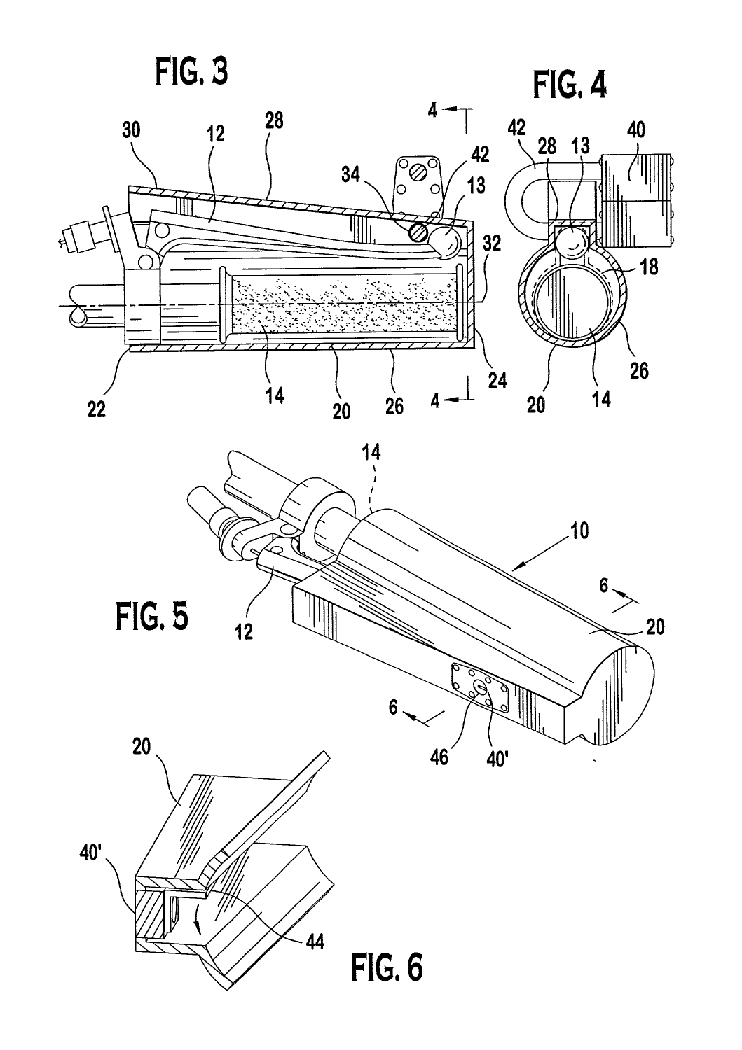

Referring now to FIG. 1, a preferred embodiment of the anti-theft device 10 in accordance with the present invention is shown. The anti-theft device 10 is used for positionally securing a handle mounted actuator, such as the control lever 12 to a handle 14. The free end 13 of the control lever 12 is preferably ball shaped or has an enlarged cross-section relative to the adjacent portion of the control lever 12. This is shown most clearly in FIG. 3.

In the preferred embodiment, the anti-theft device 10 is used with a motorcycle to cover a brake and throttle, a clutch and hand grip, or a clutch and throttle. As such, the preferred embodiment of the control lever 12 is one of a brake or clutch lever.

However, those of ordinary skill in the art will appreciate from this disclosure that the anti-theft device can be used with any one of a moped, an all terrain vehicle, a jet ski, a snowmobile, and a personal water craft. Thus, the handle mounted actuator can also serve as any one of a brake or clutch lever for a moped, all terrain vehicle (ATV), snowmobile or the like without departing from the scope of the present invention. Additionally, the handle mounted actuator could also be a throttle control lever for a personal water craft, such as a jet ski, or any other type of handle mounted control lever 12 used on the handlebar of a vehicle. The handle 14 itself may also be part of a hand-actuated throttle system which is actuated by twisting the handle 14 relative to the longitudinal axis thereof. Alternatively, the handle may be comprised of a hand grip located on the handlebar end.

The control lever 12 is preferably movable from an initial position, shown in phantom lines and indicated as 12′ in FIG. 1, in which the control lever 12′ is spaced from the handle 14, to a second position (shown in solid lines), in which the control lever 12 is moved toward the handle 14 to define, in combination with the handle 12, a secured envelope volume 18, represented by dashed lines in FIGS. 1 and 4.

As shown in FIGS. 1-3, the anti-theft device 10 is comprised of a sheath 20. The sheath 20 has a first end 22 and a second end 24. The second end 24 of the sheath 20 is preferably closed so that the sheath 20 defines an enclosure adapted to cover a majority of, and preferably, substantially all of the control lever 12, including its free end 13. The sheath 20 includes a handle-encompassing portion 26 which extends between the first and second ends 22, 24, with the handle encompassing portion 26 being adapted to slide over at least a portion of the handle 14. Preferably, the handle-encompassing portion is generally cylindrical in form and has a diameter greater than a diameter of the handle 14. However, other cross-sectional shapes could be utilized, such as a rectilinear cross-section, an oval or any other suitable shape.

The sheath 20 further includes a control lever encompassing portion 28 attached to the handle encompassing portion 26 and extending generally between the first and second ends 22, 24. The control lever encompassing portion 28 and the handle encompassing portion 26 generally encompass the secured envelope volume 18 and are adapted to slide over a majority of, and preferably encompass substantially all of, the control lever 12.

Preferably, the control lever encompassing portion 28 is formed from a tapered section 30 so that a control lever encompassing area defined by the control lever encompassing portion 28, as measured in a plane generally perpendicular to a longitudinal axis 32 of the sheath 20 generally decreases from the first end 22 toward the second end 24 of the sheath 20. The tapered section 30 is adapted to slidably engage and displace the control lever 12 into the second position as the sheath 20 is slid thereover. This ensures that the lever 12 is pressed fully toward the second position and cannot be pressed further inwardly toward the handle 14.

While the sheath 20 is illustrated in FIGS. 2 and 3 as covering almost the entire control lever 12, those skilled in the art will recognize that the requirement to cover a majority of, and preferably substantially all of the control lever is intended to mean that a portion of the control lever could be exposed at the first, open end 22 of the sheath 20. However, a majority of the control lever 12 and the handle 14 that define the secured envelope volume 18 are enclosed by the sheath 20.

Referring to FIG. 1, the preferably closed second sheath end 24 prevents removal of a handle screw 48 (the head of screw 48 is shown in phantom lines in FIG. 1 only as not all handles 14 incorporate handle screws 48) to defeat the anti-theft device 10 of the present invention. This provides further security for motorcycles and other vehicles using the anti-theft device to cover one of a brake lever and throttle, a clutch lever and throttle, and a clutch lever and handle.

In the preferred embodiment, the sheath 20 is fabricated from a metallic material such as steel or aluminum, and may be formed by machining from a solid piece, or by welding pieces together, such as a slit tube which forms the handle-encompassing portion 26, a channel-shaped piece which forms the control lever encompassing portion 28 as well as an end cap which forms the second end 24. It would also be possible to cast or forge the sheath 20 as one piece. Alternatively, the sheath 20 may be made of a reinforced plastic or composite material, such as an epoxy impregnated graphite, kevlar or fiber glass material having sufficient strength so that it could not be broken or easily removed.

In the preferred embodiment, the handle encompassing portion 26 is generally cylindrically shaped, and the control lever encompassing portion 28 is generally U-shaped, when viewed in a plane perpendicular to the longitudinal axis 32 of the handle encompassing portion 26, as shown in FIG. 4. While this shape is preferred, any other shape which generally encompasses the secured envelope volume 18 could be utilized. It will be recognized by those skilled in the art that a portion of the anti-theft device structure, such as an additional web, could be located between the handle 14 and the control lever 12, if desired, and that this would still be within the scope of the present invention. Additionally, the sheath 20 could include openings or perforations at non-critical locations, and would still be considered as encompassing the secured envelope volume 18.

Preferably, an outer surface of the sheath 20 is coated with a brightly colored paint or coating, such as a fluorescent orange colored paint or vinyl coating, so that the anti-theft device 10 is prominently visible and noticeable when installed on the vehicle handle 14.

Referring again to FIGS. 2-4, a lock 40 is connected to the sheath 20 and is adapted to secure the anti-theft device 10 to the handle 14. As shown in FIG. 2, in the first preferred embodiment of the anti-theft device 10, the lock 40 is inserted through an opening 34 defined in the control lever encompassing portion 28 of the sheath 20. The lock 40 may be a pad lock, combination lock or any other type of locking having a shank portion 42 which can be inserted through the opening 34. As shown most clearly in FIG. 3, the lock 40 blocks the return path of the protrusion 13 on the control lever 12 to secure the anti-theft device 10 to the handle 14 when the lock 40 is engaged. This holds the control lever 12 in the second position which, when the control lever 12 is for a brake, would hold the brake on. When the control lever 12 is for a clutch, this holds the clutch in the open position and prevents the motor from drivingly engaging the wheels or drive for the vehicle.

While it is preferred that the shank 42 of the lock 40 be engaged through the hole 34 in the control lever encompassing portion 28 when the sheath 20 is inserted over the handle 14 and the control lever 12, any other type of securing member which is detachably engageable through the hole 34 could also be utilized. The only requirement is that a portion of the securing member engages the protrusion 13 or blocks its return path through the control lever encompassing portion 28 of the sheath 20 to secure the anti-theft device 10 the handle 14 via contact with the control lever 12. This could for instance take the form of a pin having a hole defined at one end through which a lock or other device could be inserted after the pin is inserted through the hole 34, or a cable which is inserted through the hole 34 prior to being locked together into a continuous loop.

Referring now to FIG. 5, a second embodiment of the anti-theft device 10 is shown, in which a lock 40′ is installed on the sheath 20. As shown most clearly in FIG. 6, the lock 40′ has a pivot member 44 disposed inside the control lever encompassing portion 28 of the sheath 20. The pivot member 44 is movable between a first pivot member position (as shown in FIG. 6), in which the pivot member does not interfere with the protrusion 13 of the control lever 12 when the sheath 20 is slid over the control lever 12, and a second pivot member position, in which the pivot member 44 engages the protrusion 13 of the control lever 12 or blocks its return path through the channel encompassing portion 28 when the sheath 20 is disposed over the control lever 12 to secure the anti-theft device 10 the handle 14 via contact with the control lever.

As shown in FIG. 6, the lock 40′ with the pivot member 44 may be arranged such that when the lock 40′ is in the first position, the blocking portion of the pivot member 44 is arranged parallel to the side wall of the control lever encompassing portion 28 in the first pivot member position. In the second pivot member position, when the lock 40′ is actuated, the pivot member 44 is turned 90 degrees such that it blocks the return path through which the protrusion 13 on the control lever 12 must pass in order to remove the anti-theft device 10.

Those of ordinary skill in the art will appreciate from this disclosure that any type of locking mechanism can be incorporated into the lock 40′ without departing from the scope of the present invention. For example, the lock 40′ can be used with a slidable tumbler mechanism 46 that is moveable between a first position, in which the anti-theft device is secured to the control lever 12, and a second position, in which the anti-theft device 10 is freely slidable on and off of the handle 14 and control lever 12. When the tumbler mechanism 46 is in the first position, the outer end of the tumbler mechanism 46 is flush with the outside of the lock 40′ (as shown in FIG. 5) and the inner end (not shown) of the tumbler mechanism 46 extends into the control lever encompassing portion 28 of the sheath 20 to secure the anti-theft device 10 onto the control lever 12. The inner end of the tumbler mechanism 46 secures the anti-theft device 10 to the control lever 12 by abuttingly engaging the control lever 12 (in a similar manner to that of the shank 42 shown in FIG. 1). When the tumbler mechanism 46 is in the second (unlocked) position, the outer end of the tumbler mechanism 46 extends outwardly past the outer surface of the lock 40′ to form a nipple and the inner end is positioned so as not to interfere with the control lever 12. It is preferable, that the tumbler mechanism 46 slide outward when a key unlocks the anti-theft device 10 and that the tumbler mechanism automatically lock when a user pushes the tumbler mechanism 46 into the lock 40′ after properly positioning the anti-theft device 10 on a motorcycle or other vehicle.

In use, the handle mounted actuator in the form of the control lever 12 is secured in position relative to the handle 14 by moving the control lever 12 toward the second position, as shown in solid lines in FIG. 1. The sheath 20 is then slid onto the handle 14 and the control lever 12. The sheath 20 encloses, a majority of the control lever 12 and the handle 14 and retains the control lever 12 in the second position via contact of the protrusion 13 on the end of the control lever 12 with the control lever encompassing portion 28 of the sheath 20. The sheath 20 is secured to at least a portion of the control lever 12 or the handle 14 to lock the sheath 20 to the handle 12. Preferably, this is accomplished by inserting the shank 42 of a lock 40 through the hole 34 defined through the control lever encompassing portion 28 of the sheath or via other locking means, such as the lock 40′ mounted on the sheath 20 being actuated such that, for example, the pivot member 44 is moved from a first pivot member position, in which the pivot member does not interfere with the protrusion 13 being slid past the lock such that the sheath 20 can be installed, to a second pivot member position, in which the pivot member 44 is adapted to engage the protrusion 13 of the control lever 12 or block its return path after the sheath 20 is disposed over the control lever 12 to secure the anti-theft device 10 the handle 14 via the control lever 12.

As will be recognized by those skilled in the art, other types of locks could be utilized to secure the sheath 20 to the handle 14 or the control lever 12. Preferably, the sheath 20 protects the control lever 12 from being damaged or being released, and in the case where the handle 14 operates a throttle, prevents the handle 14 from being rotated. This provides a measure of protection for a vehicle upon which the anti-theft device 10 is mounted which was not attainable with the prior known anti-theft devices, by covering a majority of and preferably, substantially the entire operating portion of the control lever 12 and handle 14. The present anti-theft device 10 makes it more difficult for a thief to disable and remove the device 10, or merely break the handle 14 or control lever 12 and still be able to operate the vehicle. This provides superior deterrence in comparison to the prior known devices, and also provides a clear visible indicator if a protected vehicle is being operated while the anti-theft device 10 is installed due to its greater size and preferred bright coloring, which would attracted unwanted attention.

While the preferred embodiments of the invention have been described in detail, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. An anti-theft device for positionally securing a handle mounted actuator relative to a handle, the handle mounted actuator including a control lever which is moveable from an initial position, spaced from the handle, to a second position, in which the control lever is moved toward the handle to define, in combination with the handle, a secured envelope volume, the anti-theft device comprising:
a sheath having a first end and a second end, and including:
a handle encompassing portion extending between the first and second ends, the handle encompassing portion being adapted to slide over at least a portion of the handle; and
a control lever encompassing portion attached to the handle encompassing portion and extending generally between the first and second ends, wherein the control lever encompassing portion and the handle encompassing portion generally encompass the secured envelope volume and are adapted to slide over a majority of the control lever; and
a lock connected to the sheath and adapted to secure the anti-theft device to the handle, the anti-theft device is adapted to secure the control lever in the second position when the sheath is slid over the handle and the control lever.

2. The anti-theft device of claim 1, further comprising a tapered section disposed along at least a portion of the control lever encompassing portion so that a control lever encompassing area defined by the control lever encompassing portion, as measured in a plane generally perpendicular to a longitudinal axis of the sheath, generally decreases from the first end toward the second end of the sheath, wherein the tapered section is adapted to slidably engage and displace the control lever into the second position as the sheath is slid there over.

3. The anti-theft device of claim 1, wherein the second end of the sheath is closed so that the sheath defines an enclosure adapted to substantially cover substantially all of the control lever, including a free end thereof.

4. The anti-theft device of claim 1, wherein the lock is adapted to detachably engage a protrusion of the control lever, the anti-theft device being adapted to be secured to the handle when the lock is engaged with the protrusion of the control lever.

5. The anti-theft device of claim 4, wherein the lock comprises:
the control lever encompassing portion having a hole defined therethrough; and
a securing member detachably engageable with the hole, wherein when the sheath is inserted over the handle and the securing member is engaged with the hole of the control lever encompassing portion, the securing member is adapted to engage the protrusion of the control lever and to secure the anti-theft device to the handle via contact with the control lever.

6. The anti-theft device of claim 4, wherein the lock is connected to the sheath and operates a pivot member disposed inside the control lever encompassing portion, the pivot member being moveable between a first-pivot-member-position, in which the pivot member does not interfere with the protrusion of the control lever when the sheath is slid over the control lever, and a second-pivot-member-position, in which the pivot member is adapted to engage the protrusion of the control lever when the sheath is disposed over the control lever to secure the anti-theft device to the handle via contact with the control lever.

7. The anti-theft device of claim 1, wherein the control lever operates any one of a brake, a throttle, and a clutch.

8. The anti-theft device of claim 7, wherein the handle operates a throttle and the control lever operates a brake.

9. The anti-theft device of claim 7, wherein the handle operates a throttle and the control lever operates a clutch.

10. The anti-theft device of claim 1, wherein the handle encompassing portion is generally cylindrically shaped, and the control lever encompassing portion is generally “U” shaped, when viewed in a plane perpendicular to a longitudinal axis of the handle encompassing portion.

11. An anti-theft device for positionally securing a handle mounted actuator relative to a handle, the handle mounted actuator including a control lever which is moveable from an initial position, spaced from the handle, to a second position, in which the control lever is moved toward the handle, the anti-theft device comprising:
a sheath having a first end and a second end, and including:
a handle encompassing portion extending between the first and second ends and having a longitudinal axis, the handle encompassing portion being adapted to slide over at least a portion of the handle; and
a control lever encompassing portion attached to the handle encompassing portion and extending generally between the first and second ends, wherein the control lever encompassing portion includes a tapered section so that a control lever encompassing area defined by the control lever encompassing portion, as measured in a plane generally perpendicular to the longitudinal axis, generally decreases from the first end toward the second end of the sheath; and
a lock connected to the sheath and adapted to secure the anti-theft device to the handle, so that when the sheath is slid over the handle and the handle mounted actuator, the tapered section of the anti-theft device is adapted to slidably engage and displace the control lever to the second position.

12. The anti-theft device of claim 11, wherein the second end of the sheath is closed so that the sheath defines an enclosure substantially covering all of the control lever, including a free end thereof.

13. The anti-theft device of claim 11, wherein the lock is disposed on the sheath and is adapted to detachably engage a protrusion of the control lever, the anti-theft device being adapted to be secured to the handle when the lock is engaged with the protrusion of the control lever.

14. The anti-theft device of claim 13, wherein the lock comprises:
the control lever encompassing portion having a hole defined therethrough; and
a securing member that is detachably engageable with the hole, wherein when the sheath is inserted over the handle and the securing member is engaged with the hole of the control lever encompassing portion, the securing member is adapted to engage the protrusion of the control lever and to secure the anti-theft device to the handle via the control lever.

15. The anti-theft device of claim 13, wherein the lock is connected to the sheath and operates a pivot member disposed inside the control lever encompassing portion, the pivot member being moveable between a first-pivot-member-position, in which the pivot member does not interfere with the protrusion of the control lever when the sheath is slid over the control lever, and a second-pivot-member-position, in which the pivot member is adapted to engage the protrusion of the control lever when the sheath is disposed over the control lever to secure the anti-theft device to the handle via the control lever.

16. A combination of a vehicle and an anti-theft device, the combination comprising:
the vehicle;
a handle operatively connected to the vehicle;
a handle mounted actuator located on the handle and including a control lever which is moveable from an initial position, spaced from the handle, to a second position, in which the control lever is moved toward the handle, to define, in combination with the handle, a secured envelope volume; and
the anti-theft device being detachable engageable with the handle and comprising:
a sheath having a first end and a second end, and including:
a handle encompassing portion extending between the first and second ends, the handle encompassing portion being slidable over at least a portion of the handle; and
a control lever encompassing portion attached to the handle encompassing portion and extending generally between the first and second ends, wherein the control lever encompassing portion and the handle encompassing portion generally encompass the secured envelope volume and are slidable over a majority of the control lever; and
a lock connected to the sheath that secures the anti-theft device to the handle, so that when the sheath is slid over the handle and the control lever, the anti-theft device secures the control lever in the second position.

17. The combination of claim 16, further comprising a tapered section disposed along at least a portion of the control lever encompassing portion so that a control lever encompassing area defined by the control lever encompassing portion, as measured in a plane generally perpendicular to a longitudinal axis of the sheath, generally decreases from the first end toward the second end of the sheath, wherein the tapered section is adapted to slidably engage and displace the control lever into the second position as the sheath is slid there over.

18. The combination of claim 17, wherein the second end of the sheath is closed so that the sheath defines an enclosure adapted to cover substantially all of the control lever, including a free end thereof.

19. The combination of claim 16 wherein the control lever operates any one of a brake, a throttle, and a clutch.

20. The combination of claim 19, wherein the handle operates a throttle and the control lever operates a brake.

21. The anti-theft device of claim 19, wherein the handle operates a throttle and the control lever operates a clutch.

22. The combination of claim 16, wherein the vehicle is any one of a motorcycle, an all terrain vehicle, and a jet ski.

23. A method of positionally securing a handle mounted actuator relative to a handle, the handle mounted actuator including a control lever having an initial position, spaced from the handle, and a second position, in which the control lever is moved toward the handle, the method comprising:
moving the control lever into the second position; and
sliding a sheath onto the handle and the control lever, the sheath enclosing a majority of the control lever and the handle and retaining the control lever in the second position.

24. The method of claim 23, further including securing the sheath to at least a portion of the control lever or the handle to lock the sheath on the handle.

25. The method of claim 23, wherein the step of sliding the sheath comprises sliding the sheath over the handle and the control lever, the outer surface of the sheath defining an enclosure having an opening through which an interior of the enclosure is accessible, the control lever being located in the interior when the sheath is attached to the handle.

26. The method of claim 25, further comprising protecting the control lever from being damaged.

27. The method of claim 26, further comprising preventing the handle from being rotated to operate a throttle.
